(19) United States
(12) Patent Application Publication
(10) Pub. No.: US 2013/0293958 A1
(43) Pub. Date: Nov. 7, 2013

(54) Night Vision Goggle Cover and Cover Holder

(71) Applicant: Timothy Alan McDonald, Stillwater, OK (US)

(72) Inventor: Timothy Alan McDonald, Stillwater, OK (US)

(21) Appl. No.: 13/887,425

(22) Filed: May 6, 2013

Related U.S. Application Data
(60) Provisional application No. 61/643,241, filed on May 5, 2012.

(51) Int. Cl. G02B 23/16

(52) U.S. Cl. CPC G02B 23/16
USPC 359/511

(57) ABSTRACT

The embodiments of the Lens Protector are comprised of two large eyepiece lens covers, two small objective lens covers, and a flat connective lanyard. The embodiments of the optical protection device, the larger end covers are placed over the eye optical lenses and the smaller end covers are placed over the objective lenses to protect the eye lenses and objective lenses from damage due to light or damage due to foreign objects being deposited on the lens glass. The lanyard with the X-shaped connection allows the end covers to be maintained in place relative to each other and also prevents the end covers from being entangled thereby allowing ease of replacement of the end covers onto the optical lenses when the optical device is to be stored or taken out of application use.

### CROSS-REFERENCE TO RELATED APPLICATIONS

This application claims benefit of U.S. Provisional Application No. 61/643,241, filed on May 5, 2014. U.S. Provisional Patent Application No. 61/643,241 are incorporated by reference in their entirety for all purposes as if fully set forth herein.

### STATEMENT REGARDING FEDERALLY SPONSORED RESEARCH OR DEVELOPMENT

Not applicable

### FIELD OF THE EMBODIMENTS

The field of the embodiments is the general area of optical lenses protection. More specifically, the field of the embodiments is the protection of optical lenses, including without limitation night vision goggles, by covering the ends of the optical lenses with a polymeric cover.

### BACKGROUND OF THE EMBODIMENTS

The background of the embodiments includes the general area of protection of optical equipment including all optical lenses, binoculars, and night vision goggles. Binoculars and night vision goggles are finely tuned instruments that can be affected by a variety of factors. In particular night vision goggles are extremely expensive and sensitive optical instruments. All of these delicate optical instruments can be affected by dirt, smoke, fingerprints, and other foreign matter. In addition, night vision goggles can be affected by incident light entering the night vision goggles unexpectedly. Therefore, all users and owners of delicate optical instruments desire to have the means but protecting their investment.

Most optical instruments such as binoculars and night vision goggles come with lens covers. These lens covers are typically held with a bungee cord type device. The bungee cord type device commonly become tangled and make the lens covers difficult to apply. In some applications difficulty in applying the lens cover or protector results in the user simply not using the protective device. For a device that is prohibitively expensive, such as a night vision goggle, this is an unacceptable practice. Therefore, a need exists for an easy to use device that serves to protect the lens systems of the optical device

### SUMMARY OF THE EMBODIMENTS

In summary, the embodiments of the Lens Protector are comprised of two large eyepiece lens covers, two small objective lens covers, and a flat connective lanyard. The embodiments of the optical protection device, the larger end covers are placed over the eye optical lenses and the smaller end covers are placed over the objective lenses to protect the eye lenses and objective lenses from damage due to light or damage due to foreign objects being deposited on the lens glass. When the optical device is to be used, the covers can be removed from the objective and eye piece lenses for use of the optical device. The lanyard with the X-shaped connection allows the end covers to be maintained in place relative to each other and also prevents the end covers from becoming entangled thereby allowing ease of replacement of the end covers onto the optical lenses when the optical device is to be stored or otherwise not used, but maintains the optical device for ready use.

In this respect, it is to be understood that the embodiments in this application are not limited to the details of construction and to the arrangements of the components set forth in the description or illustrated in the drawings. The embodiments are capable of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the embodiments described in this application. Additional benefits and advantages of the present embodiments will become apparent in those skilled in the art to which the embodiments relate from the description of the preferred embodiment and the appended claims, taken in conjunction with the accompanying drawings. It is important, therefore, that the claims be regarded as including such equivalent constructions insofar as they do not depart from the spirit and scope of the embodiments described herein.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application, which is measured by the claims, nor is it intended to be limiting as to the scope of the embodiments in any way.

### BRIEF DESCRIPTION OF THE DRAWINGS

FIG. 1 is a perspective view schematic of an embodiment of the lens protector.

FIG. 2 is a perspective view of embodiment of the lens protector installed on an optical device.

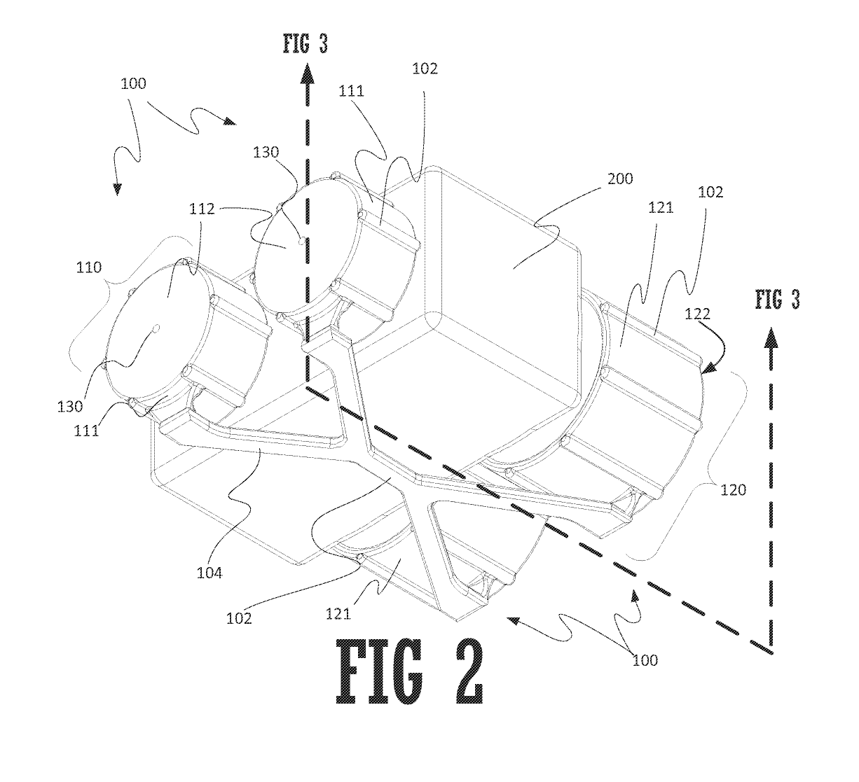

FIG. 3 is the sectional view of an embodiment of the lens protector illustrating how the lens protector is securely attached to the optical device.

FIG. 4A is a top view of an embodiment of the lens protector; FIG. 4B is a side view of an embodiment of the lens protector.

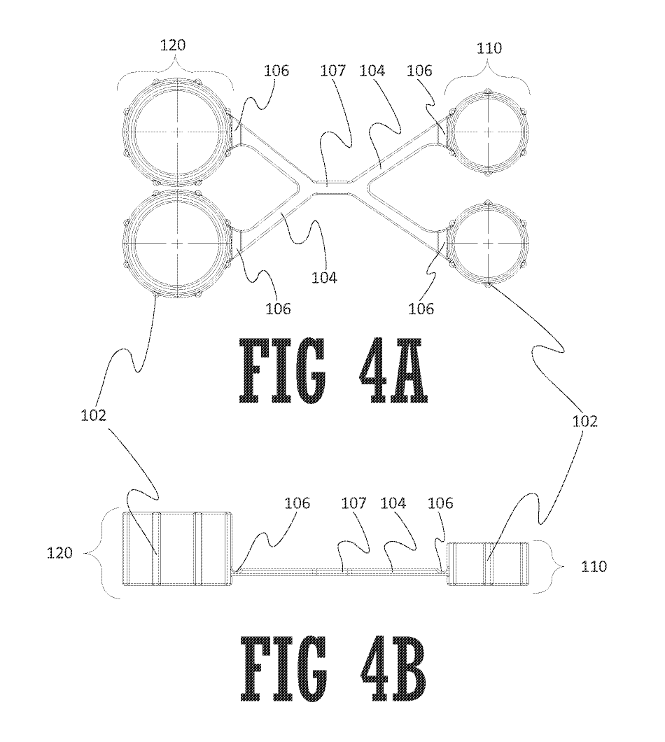

FIG. 5 is a perspective view of an embodiment of the lens protector with shallow lens covers.

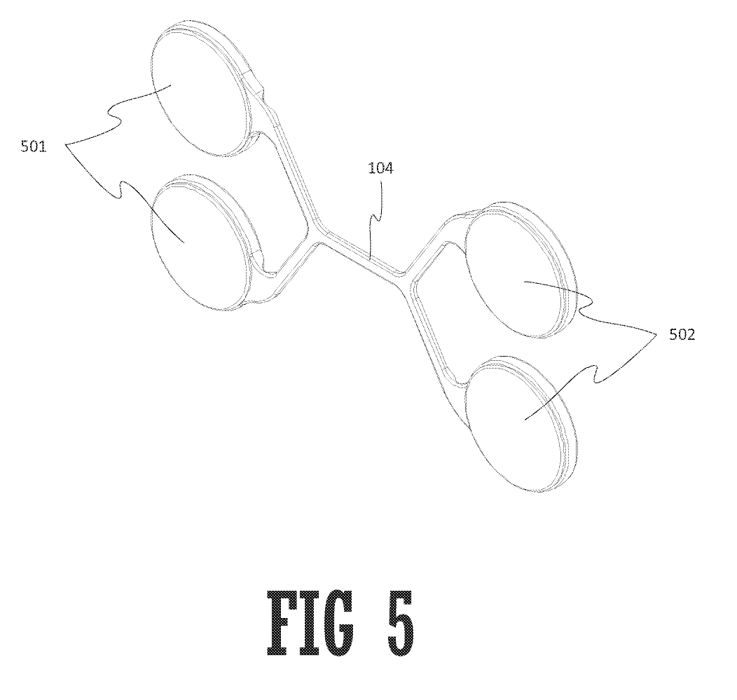

FIG. 6A is a top view of an embodiment of the lens protector; FIG. 6B is a side view of an embodiment of the lens protector with shallow lens covers.

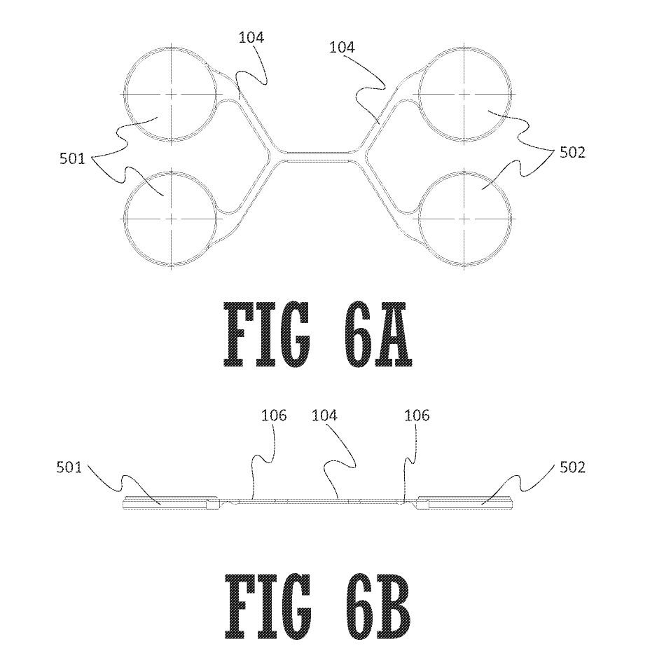

### DETAILED DESCRIPTION OF THE PREFERRED EMBODIMENTS

Embodiments of the lens protector 100 are comprised of two small objective lens covers 110, two large eyepiece lens covers 120, and a flat connective lanyard 103. In another embodiment, the lens protector has one large eyepiece lens cover 120 and one small objective lens cover 110. In one embodiment, the two large eyepiece lens covers 120 are sized so that they can accept an eyepiece lens from a night vision goggle and two small objective lens covers 110 are sized so they can accept the objective lens from a night vision goggle.

The small objective lens covers 110 comprise a small outer cylinder 111 with one end of the small outer cylinder 111 closed with a small end cover 112 and the other end of the small outer cylinder 111 open. The small outer cylinder 111 and the small end cover 112 are integrally formed together to form the objective lens covers 110. Further comprising the small objective lens covers 110, the small outer cylinders 111 form an objective lens cover ridge 113 on the edge of both the open ends of the small outer cylinders 111. The objective lens cover ridges 113 allow the exterior of the objective lens of the optical device to be firmly gripped by small objective lens covers 110 via a resistance fit. Another purpose of the objective lens cover ridge 113 is to form a seal to prevent light, moisture, debris or any other foreign material from entering the objective lens of the optical device.

The large eyepiece lens covers 120 comprise a large outer cylinder 121 with one end of the large outer cylinder 121 closed with a large end cover 122 and the other end of the large outer cylinder 121 open. The large outer cylinder 121 and the large end cover 122 are integrally formed together to form the eyepiece lens covers 120. Further comprising the large eyepiece lens covers 120, the large outer cylinders 121 form an eye lens cover ridge 123 on the edge of both the open ends of the large outer cylinders 121. The eyepiece lens cover ridges 123 allow the exterior of the eye lenses of the optical device to be firmly gripped by eyepiece lens covers 120 via a resistance fit. Another purpose of the eyepiece lens cover ridges 123 is to form a seal to prevent light, moisture, debris or any other foreign material from entering the eyepiece lens of the optical device.

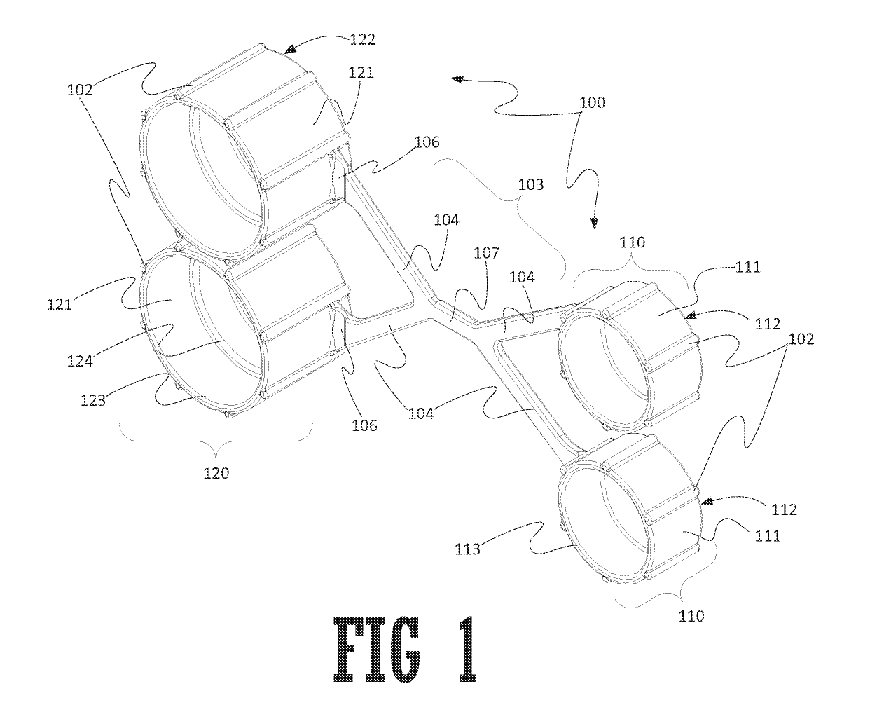

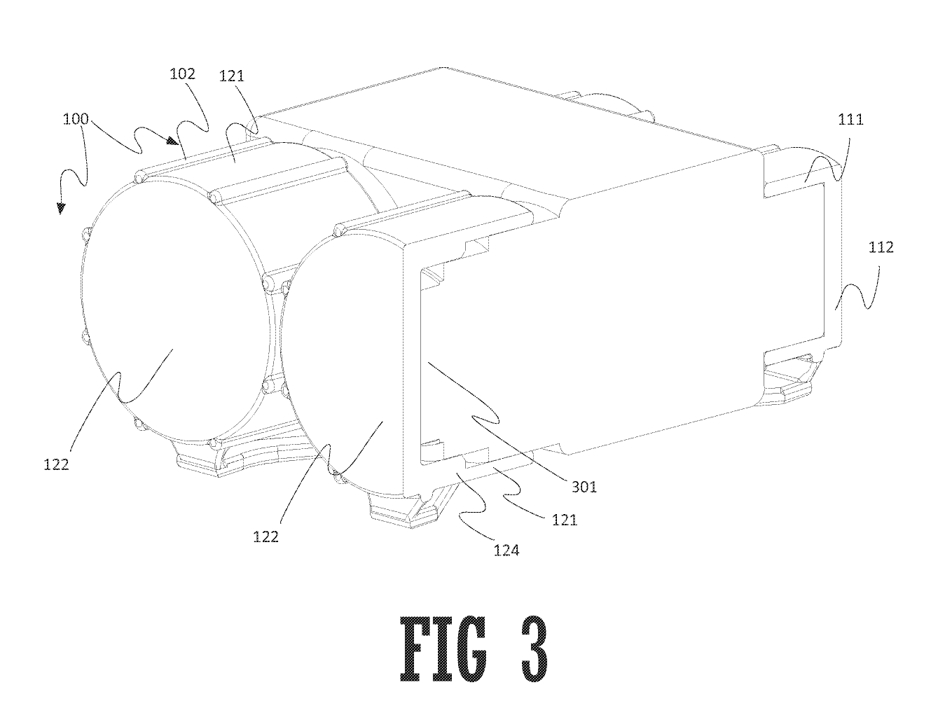

The large eyepiece lens covers 120 comprise a raised inner support 124 for the end of the eyepiece lens 301. See FIGS. 1 and 3. The raised inner support 124 serves to provide added protection for the eyepiece lens 301 from mechanical or physical damage from bumps and other impacts. In addition, the raised inner support 124 serves and to provide added support for the large eyepiece lens covers 120 when installed over the eyepiece lens 301 by providing additional surface area for the friction fit. That is, the raised inner support 124 makes unintentionally removing the large eyepiece lens covers 120 more difficult.

Formed on the large eyepiece lens covers 120 are a plurality of bosses 102 which provide a means for the user to grip the large eyepiece lens covers 120 for installation and removal of the large eyepiece lens covers 120 from the optical device 200. In addition, formed on the small objective lens covers 110 are a plurality of bosses 102 which provide a means for the user to grip the small objective lens covers 110 for installation and removal of the small objective lens covers 110 from the optical device 200.

The flat connective lanyard 103 is comprised of an “X” which holds the two large eyepiece lens covers together with the two small objective lens covers. The “X” is comprised of a central connection 107 and four legs 104. The connective lanyard 103 is further comprised of grooves 106 at the junction between each eyepiece lens covers, each objective lens covers and the connective lanyard. These grooves allow the connective lanyard to flex at the point of connection between the connective lanyard and the lens cover. The flat connective lanyard 103 is made from polymeric material and is rigid enough to prevent the end covers from entangling with each other yet elastic enough to allow easy placement of the end covers onto the optical lenses of the optical device.

In another embodiment of the lens protector 100, the small objective lens cover or covers 110 forms a pinhole 130. These pinholes 130 allow for the use to adjust the optical device in normal lighting conditions without damaging the optical device. For example, in normal indoor or sunlight conditions, the pinhole 130 allows a limited but sufficient amount of light to enter for the use to adjust a night vision optical device without letting too much light to enter that would damage the optical device.

In another embodiment, the lens protector 100 is comprised of two objective lens covers 501, two eyepiece lens covers 502, and a flat connective lanyard 104. In this embodiment, the objective lens covers 501 and eyepiece lens covers 502 are essentially thin disks that attach to the respective lens via a resistance fit. This embodiment of the lens protector 100 forms a seal to prevent light, moisture, debris or any other foreign material from entering the eyepiece lens of the optical device. In addition, this embodiment will fit into the ends of the eyepiece and objective lenses and seal the lenses from the surrounding environment.

In the best mode of operation of the embodiments of the optical protection device, the larger end covers are placed over the eye optical lenses and the smaller end covers are placed over the objective lenses to protect the eye lenses and objective lenses from damage due to light or damage due to foreign objects being deposited on the lens glass. When the optical device is to be used, all four end covers can be removed from the objective and eye piece lenses for use of the optical device. The lanyard with the X-shaped connection allows the end covers to be maintained in place relative to each other and also prevents the end covers from being entangled thereby allowing ease of replacement of the end covers onto the optical lenses when the optical device is to be stored or taken out of application use.

I claim:

1. A lens protector comprising
a. two large eyepiece lens covers where each eyepiece lens cover comprises
i. a large outer cylinder and a large end cover
ii. wherein one end of the large outer cylinder is closed with the large end cover and the other end of the large outer cylinder open;
iii. wherein the large outer cylinder and the large end cover are integrally formed together
iv. an eye lens cap ridge on the open edge of the large outer cylinders and
v. a raised inner support;
b. two small objective lens covers;
c. a flat connective lanyard wherein the lanyard is in the form of an “X” and holds the two large eyepiece lens covers and the two small objective lens covers together;

2. The lens protector as described in claim 1 comprising
a. grooves in the lanyard where it connects to the two large eyepieces and two small objective lens covers allow the lanyard to bend;
b. wherein the inside of the larger outer cylinder forms a ridge that serves as a seal between the optical lens and the surrounding environment, and
c. wherein the small diameter inner cylinder with a smaller height forms at the center a small pinhole allowing adjustments of a night vision goggle in indoor lighting conditions.

3. The lens protector as described in claim 2 wherein
a. the two large eyepiece lens covers are sized so that they can accept an eyepiece lens from a night vision goggle;
b. the two small objective lens covers are sized so that they can accept an objective lens from a night vision goggle;
c. wherein each of the two large caps form a ridge on the inside of the large caps such that the protective edge or body around the eyepiece lens rests on the bottom in the large caps and the protective edge or body around the diopter adjustment mechanism rests on the ridge in the large caps;
d. wherein the two large caps form bosses on the outside of the caps;
e. wherein the two small caps form bosses on the outside of the caps;

4. The lens protector as described in claim 3 wherein the connective lanyard is comprised of
a. an off-set four-armed bridge wherein a four-armed bridge
i. offset is in the shape of an “X”
b. four connective arms wherein two connect to the large caps and two connect to the small caps
c. four connective arms wherein cut-outs in the said arms connect the arms to the two large caps and arms to the two small caps
d. wherein the four-armed bridge and the four connective arms are flat

5. The lens protector as described in claim 3 wherein the lens covers are comprised of a material manufactured from a black color and wherein there is formed a pinhole in center of objective lens cover.

6. The lens protector as described in claim 3 wherein the lens covers are comprised of a material manufactured from a red color and wherein there is formed a pinhole in center of objective lens cover.

7. The lens protector as described in claim 1 comprising
a. a plurality of bosses formed on the large eyepiece lens covers, and
b. a plurality of bosses formed on the small objective lens covers.

8. The lens protector as described in claim 1 comprising the small objective lens cover or covers forming a pinhole.
